(19) United States
(12) Patent Application Publication
(10) Pub. No.: US 2026/0051139 A1
(43) Pub. Date: Feb. 19, 2026

(54) OBJECT DETECTION WITH DYNAMIC CONFIDENCE THRESHOLDS

(71) Applicant: Synaptics Incorporated, San Jose, CA (US)

(72) Inventors: Ran Zvi Bezen, Ramat Gan (IL); Dmitri Lvov, Ramat Hasharon (IL)

(73) Assignee: Synaptics Incorporated, San Jose, CA (US)

(21) Appl. No.: 18/808,217

(22) Filed: Aug. 19, 2024

(51) Int. Cl. G06V 10/25; G06T 7/20; G06V 10/764

(52) U.S. Cl. CPC G06V 10/25; G06T 7/20; G06V 10/764; G06V 2201/07

(57) ABSTRACT

This disclosure provides methods, devices, and systems for object detection in images. The present implementations more specifically relate to object detection with dynamic confidence thresholds. In some implementations, an image analysis system may map a bounding box to a first image in a sequence of images based on an object detection operation that assigns a confidence score to the bounding box indicating a likelihood that an object of interest is included in the bounding box; determine temporal information associated with the first image based on a second image in the sequence of images; select one of a plurality of confidence thresholds based at least in part on the temporal information; and selectively discard the bounding box based on whether the confidence score exceeds the selected one of the plurality of confidence thresholds.

### TECHNICAL FIELD

The present implementations relate generally to object detection, and specifically to object detection with dynamic confidence thresholds.

### BACKGROUND OF RELATED ART

Computer vision is a field of artificial intelligence (AI) that mimics the human visual system to draw inferences about an environment from images or video of the environment. Example computer vision technologies include object detection, object classification, object identification, and object tracking, among other examples. Object detection encompasses various techniques for detecting objects in the environment that belong to a known class (such as humans, vehicles, or animals). An output of an object detection operation may be one or more bounding boxes indicating respective positions within an image where objects are detected. Each bounding box may be assigned a confidence score indicating an estimated likelihood that the bounding box contains an object of interest (such as a person).

Many object detection models are susceptible to detecting objects of interest in images or video that do not contain such objects (also referred to as “false positive” detections). Existing techniques for reducing false positive detections include discarding detections having confidence levels that are below a threshold confidence level. However, existing thresholding techniques often rely on a single confidence threshold, which cannot account for temporal changes in a sequence of images (such as movement of the object(s) of interest).

### SUMMARY

This Summary is provided to introduce in a simplified form a selection of concepts that are further described below in the Detailed

Description This Summary is not intended to identify key features or essential features of the claimed subject matter, nor is it intended to limit the scope of the claimed subject matter.

One innovative aspect of the subject matter of this disclosure can be implemented in a method of object detection in images. The method includes mapping a bounding box to a first image in a sequence of images based on an object detection operation that assigns a confidence score to the bounding box indicating a likelihood that an object of interest is included in the bounding box; determining temporal information associated with the first image based on a second image in the sequence of images; selecting one of a plurality of confidence thresholds based at least in part on the temporal information; and selectively discarding the bounding box based on whether the confidence score exceeds the selected one of the plurality of confidence thresholds.

Another innovative aspect of the subject matter of this disclosure can be implemented in a computing system, which includes one or more processors and a memory coupled to the one or more processors. The memory stores instructions that, when executed by the one or more processors, cause the computing system to map a bounding box to a first image in a sequence of images based on an object detection operation that assigns a confidence score to the bounding box indicating a likelihood that an object of interest is included in the bounding box; determine temporal information associated with the first image based on a second image in the sequence of images; select one of a plurality of confidence thresholds based at least in part on the temporal information; and selectively discard the bounding box based on whether the confidence score exceeds the selected one of the plurality of confidence thresholds.

### BRIEF DESCRIPTION OF THE DRAWINGS

The present implementations are illustrated by way of example and are not intended to be limited by the figures of the accompanying drawings.

FIG. 1 shows a block diagram of an example image analysis system, according to some implementations.

FIG. 2A shows a decision flow diagram for an example process for selecting a confidence threshold and determining whether to keep or discard a bounding box based on the selected threshold, according to some implementations.

FIG. 2B shows a decision flow diagram for another example process for selecting a confidence threshold and determining whether to keep or discard a bounding box based on the selected threshold, according to some implementations.

FIG. 3 shows an example set of captured images and object detection based on those images, according to some implementations.

FIG. 4 shows a block diagram of another example image analysis system, according to some implementations.

FIG. 5 shows a decision flow diagram for an example process for detecting and tracking an object, according to some implementations.

FIG. 6 shows a sequence of captured images and associated trackers, according to some implementations.

FIG. 7 shows another block diagram of an example image analysis system, according to some implementations.

FIG. 8 shows an illustrative flowchart depicting an example operation for object detection in images, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

As described above, computer vision techniques may include object detection, in which the issue of false positives is a perennial challenge. A common approach to reducing false positives is to discard detections having confidence values that are below a threshold confidence level. Some object detection techniques use a single confidence threshold for determining whether to discard detections. However, aspects of the present disclosure recognize that a single (static) threshold cannot account for temporal changes in image characteristics across a sequence of images.

Particularly, aspects of the present disclosure recognize that certain types of objects can be expected to exhibit motion or movement over a given duration of time (such as persons, animals, and vehicles). Thus, the ability to detect the movement of such objects (such as changes in the object's location and/or movement of the object's extremities) can aid in distinguishing between actual objects of interest (e.g., a live person) and false detections (e.g., framed pictures on a wall or a statue of a person). Thus, in some aspects, an object detection model may reduce false detections by dynamically changing a confidence threshold for filtering detections based on temporal characteristics of a sequence of images.

Various aspects of this disclosure relate generally to object detection, and more particularly, to object detection using dynamic confidence thresholds. In some aspects, an image analysis system may be configured to map a bounding box to a first image in a sequence of images based on an object detection operation that assigns a confidence score to the bounding box indicating a likelihood that an object of interest is included in the bounding box; determine temporal information associated with the first image based on a second image in the sequence of images; select one of a plurality of confidence thresholds based at least in part on the temporal information; and selectively discard the bounding box based on whether the confidence score exceeds the selected one of the plurality of confidence thresholds.

Particular implementations of the subject matter described in this disclosure can be implemented to realize one or more of the following potential advantages. By selecting one of a plurality of confidence thresholds based on temporal information associated with the sequence of images, aspects of the present disclosure can more effectively filter static objects that would otherwise trigger false positive detections (such as picture frames hanging on a wall) without sacrificing the accuracy of object detection for actual objects of interest (such as a live person in front of the camera). Accordingly, the image analysis system of the present implementations can reduce the rate of false detections.

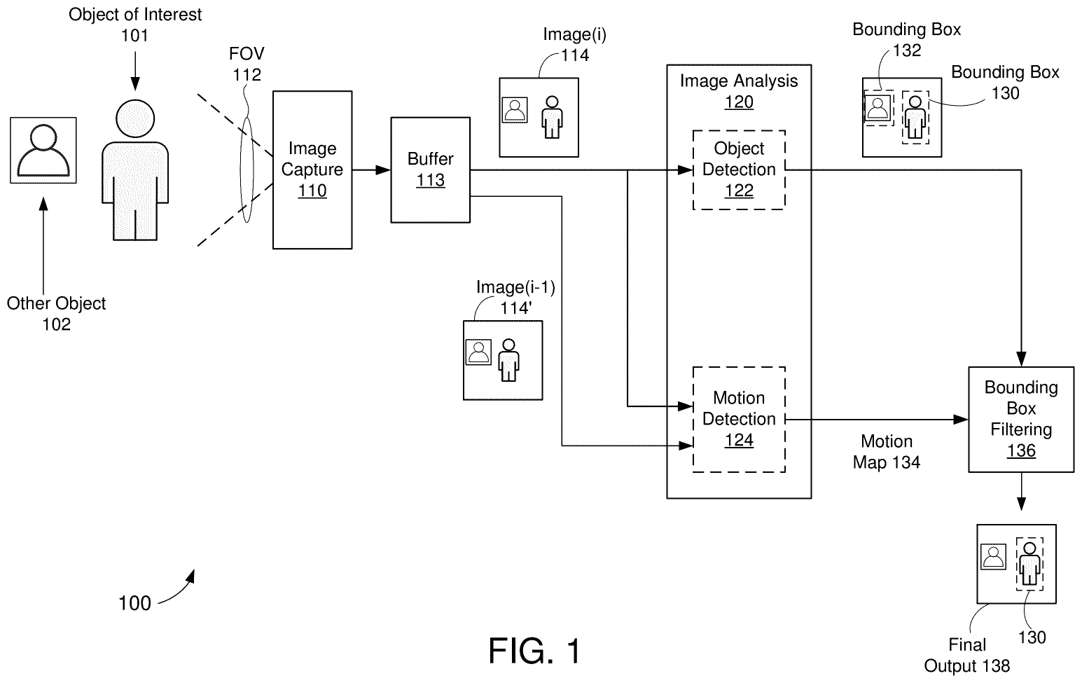

FIG. 1 shows a block diagram of an example image analysis system 100, according to some implementations. In some aspects, the image analysis system 100 may be configured to detect one or more objects of interest (also referred to as “target objects”) and generate inferences about the objects of interest. In some implementations, an inference may include a bounding box indicating a position or location of the object of interest in relation to the image.

The system 100 includes an image capture component 110, an image analysis component 120, and a bounding box filtering component 136. The image capture component 110 may be any imaging sensor or device (such as a camera) configured to capture a pattern of light in its field-of-view (FOV) 112 and convert the pattern of light to digital images (e.g., images 114 and 114′). For example, a first digital image 114 may include an array of pixels (or pixel values) representing the pattern of light in the FOV 112 of the image capture component 110. In some implementations, the image capture component 110 may continuously (or periodically) capture a series of images representing a digital video. As shown in FIG. 1, an image 114′ may be captured at a first time (e.g., a time (t−1)), and an image 114 may be captured at a second time (e.g., a time t). In the example of FIG. 1, an object of interest 101 located within the FOV 112 is depicted as a person, and another object 102 (e.g., an object of non-interest) located within the FOV 112 is depicted as a framed picture of a person. As a result, the images 114′ and 114 may include the object of interest 101 and the other object 102. In some aspects, the object of interest 101 may be an object that is predicted to move or be otherwise incapable of remaining static over long durations of time. For example, the image 114 represents the i^{th} image, in a sequence of images, captured by the image capture component 110, and the image 114′ represents the (i−1)^{th} image in the sequence of images. In some implementations, images captured by the image capture component 110 (e.g., the images 114) may be stored in a buffer 113 (or a cache or other storage).

In some aspects, the image analysis component 120 may detect one or more objects, and determine a corresponding bounding box for each of those detected objects, based on an object detection model 122. The object detection model 122 may be trained or otherwise configured to detect objects of interest in images or video. For example, the object detection model 122 may apply one or more transformations to the pixels in the image 114 to create one or more features that can be used for object detection. More specifically, the object detection model 122 may compare the features extracted from the image 114 with a known set of features that uniquely identify a particular class of objects (such as humans) to determine a presence or location of any target objects in the image 114. In some implementations, the object detection model 122 may be a neural network model. In some other implementations, the object detection model 122 may be a statistical model. In some aspects, the image analysis component 120 may assign a confidence score (which may be referred to as a confidence, confidence level, confidence value, or the like) to the bounding box indicating a likelihood or probability that an object of interest is included in the bounding box (e.g., a likelihood that the corresponding bounding box contains an object of interest).

In some implementations, the image analysis component 120 may output an annotated image that includes one or more bounding box(es) indicating the location(s) of the corresponding object(s) within the image 114. In some implementations, image analysis component 120 may output coordinates (e.g., x-y coordinates in a coordinate space of the digital image 114 and/or the image capture component 110) of two or more corners defining each bounding box. As shown in FIG. 1, the image analysis component 120 determines bounding boxes 130 and 132 for detections of objects 101 and 102, respectively, and those bounding boxes 130 may be processed further to reject potential false detections.

In some aspects, the other object 102 in the images 114/114 may be static (e.g., stationary). For example, in some implementations, the image capture component 110 may be a camera that is static (e.g., not moving or pivoting along any degree of freedom), and the other object 102 is also static as well. Meanwhile, the object of interest 101 may be an object that is likely to move or is unlikely to remain static over long durations of time (e.g., live humans or animals). In some implementations, the object detection model 122 may be trained on static images and therefore cannot distinguish between static objects (e.g., picture frames) and actual objects of interest. Further, aspects of the present disclosure recognize that certain objects of interest are unlikely to remain static over time. Accordingly, aspects of the present disclosure recognize that temporal information, including but not limited to information regarding detected motion or lack thereof in the images 114) may be used to dynamically select a confidence threshold for filtering bounding boxes 130 and 132.

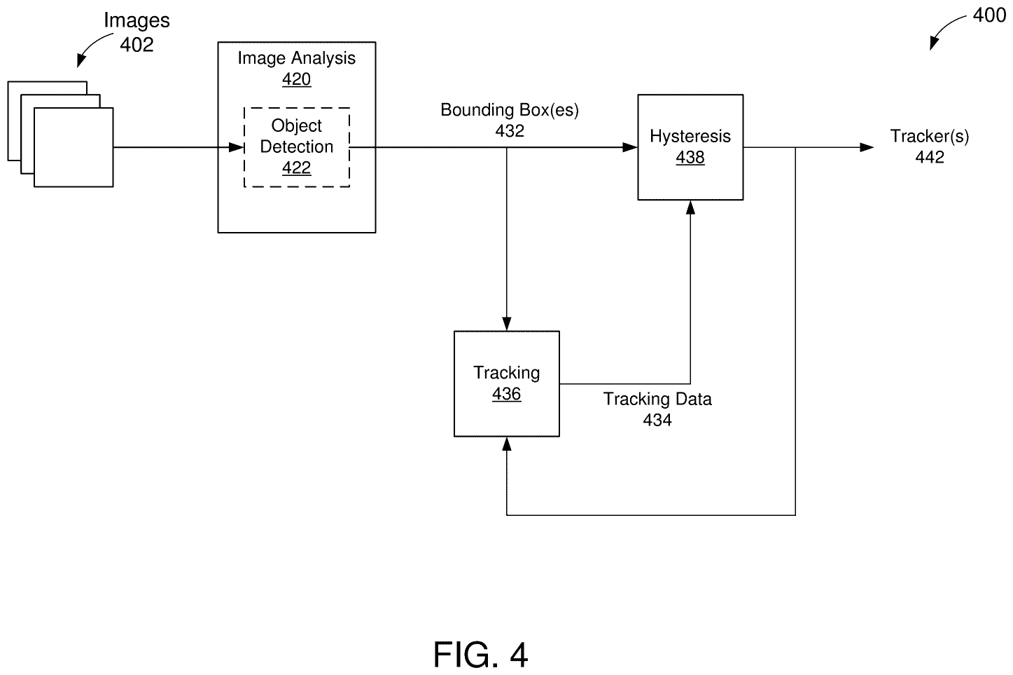

As used herein, the term “temporal information” may refer to any time-based information derived from a sequence of images (e.g., images captured at different instances of time). In some implementations, temporal information may include motion detection information (e.g., motion map 134) determined from changes in pixel value between successive images in a sequence of images (e.g., images 114′ and 114). In some other implementations, temporal information may include object detection information (e.g., bounding boxes and positions thereof) associated with successive images in the sequence (such as described with reference to FIGS. 4-6).

The image analysis component 120 may be further configured to detect motion based on the images 114′ and 114. In some aspects, the image analysis component 120 may detect differences (e.g., changes to one or more pixels values, including changes in color, shading, lighting, and/or the like) between successive images captured over any given duration of time. For example, the changes in pixel values may indicate movement of one or more objects or changes in lighting or shading. In some implementations, the image analysis component 120 may attribute changes in pixel values to movement of objects and/or motion (also referred to as “area of motion” or “area of detected motion”) in the images based on a motion detection model 124. That area of pixels may indicate an object moving across the field of view 112. The image analysis component 120 may generate a motion map 134 indicating one or more areas of motion associated with the images 114′ and 114. In some implementations, the motion detection model 124 may be a neural network model. In some other implementations, the motion detection model 124 may be a statistical model.

The bounding box filtering component 136 is configured to filter bounding boxes based on a set of multiple confidence thresholds. The bounding box filtering component 136 may receive the bounding boxes 130 and 132, including their assigned confidence scores, and the motion map 134 as inputs. The bounding box filtering component 136 may determine, for each bounding box, whether the bounding box is associated with motion (or static) based on the motion map 134. In some implementations, the bounding box filtering component 136 may compare the area of the bounding box with an area of detected motion in the motion map 134 for overlap. In some other implementations, the bounding box filtering component 136 may compare a centroid of the bounding box with a centroid of an area of detected motion based on a distance threshold.

If a bounding box overlaps an area of detected motion, or the centroid of the bounding box is within a threshold distance of the centroid of an area of detected motion, the bounding box filtering component 136 may determine that the bounding box is associated with motion (e.g., the object detected therein is moving). Otherwise, if a bounding box does not overlap any areas of detected motion, and the centroid of the bounding box is beyond a threshold distance of any areas of detected motion, the bounding box filtering component 136 may determine that the bounding box is not associated with motion (e.g., the object detected therein is static).

In some aspects, the bounding box filtering component 136 may further compare the confidence score for each bounding box to one of multiple confidence thresholds based on whether the bounding box is associated with motion. More specifically, if the bounding box filtering component 136 determines that a bounding box is associated with motion, the bounding box filtering component 136 may compare the corresponding confidence score with a relatively low confidence threshold (referred to herein as “ct_low”) from the set of multiple confidence thresholds. On the other hand, if the bounding box filtering component 136 determines that a bounding box is not associated with motion, the bounding box filtering component 136 may compare the corresponding confidence score with a relatively high confidence threshold (referred to herein as “ct_high”) from the set of multiple confidence thresholds.

In some aspects, the bounding box filtering component 136 may discard any bounding boxes that have confidence scores below the selected confidence threshold for the bounding box. For example, if the confidence score for a given bounding box exceeds the selected confidence threshold for the bounding box, the bounding box filtering component 136 may “keep” or maintain (or otherwise preserve) the bounding box in the final output 138 of the image analysis system 100. On the other hand, if the confidence score for a given bounding box does not exceed the selected confidence threshold for the bounding box, the bounding box filtering component 136 may discard the bounding box from the final output 138 of the image analysis system 100.

As described above, detected objects not associated with motion may be compared to a higher confidence threshold, and detected objects associated with motion may be compared to a lower confidence threshold. By selecting different confidence thresholds based on whether the bounding box is associated with motion, aspects of the present disclosure can more effectively filter static objects that would otherwise trigger false positive detections (such as picture frames hanging on a wall) without sacrificing the accuracy of object detection for actual objects of interest (such as a live person in front of the camera). For example, a static object would need to pass a higher confidence threshold to be detected as an object of interest, whereas a moving object of interest can pass a lower confidence threshold to be detected as an object of interest.

In some implementations, the value for ct_low may be 0.50 and the value for ct_high may be 0.75 (on a scale from 0 to 1, where 0 represents the lowest possible confidence score and 1 represents the highest possible confidence score). In some implementations, the values for ct_low and ct_high may be predetermined or configured based on empirical experimentation and testing (e.g., tested and validated using test image inputs) to minimize false detections.

In the example of FIG. 1, the bounding box filtering component 136 compares the bounding boxes 130 and 132 to the motion map 134 and determines that the bounding box 130 is associated with motion (e.g., due to movement of the object 101 between the (i−1)^{th} image and the i^{th} image), but that the bounding box 132 is not associated with motion (e.g., due to the other object 102 being stationary). Accordingly, the bounding box filtering component 136 selects ct_low as the confidence threshold for the bounding box 130 and selects ct_high as the confidence threshold for the bounding box 132. Assuming, for illustration, that the confidence score for each of the bounding boxes 130 and 132 is 0.60, and that ct_low=0.5 whereas ct_high=0.75, the bounding box filtering component 136 may keep the bounding box 130 and discard the bounding box 132 from the final output 138. The bounding box filtering component 136 may output the bounding box 130 in a final output 138 of the image analysis system 100. In some implementations, the final output 138 may include any bounding boxes that are not discarded (e.g., bounding box 130). As shown for example in FIG. 1, the bounding box 130 may be overlaid on the image 114 for display to a user.

FIG. 1 illustrates the bounding box filtering component 136 as a distinct component from the image analysis component 120. In some implementations, the bounding box filtering component 136 may be included or integrated within the image analysis component 120. For example, in some implementations, the object detection model 122 may include the bounding box filtering component 136. The image analysis component 120 may perform the threshold selection and the bounding box filtering described herein via the object detection model 122.

In some implementations, the image analysis component 120 may receive, or otherwise have access to, data regarding movement and/or re-orientation of the image capture component 110. For example, if the image capture component 110 moves, pans, or the like, the image capture component 110 or another system controlling the image capture component 110 (e.g., a computing system operated by a user) may transmit movement data of the image capture component 110 to the image analysis component 120. The image analysis component 120 may use the data to determine (e.g., estimate) a movement of the image capture component 110 and compensate for such movement when performing object detection operations using the motion detection model 124.

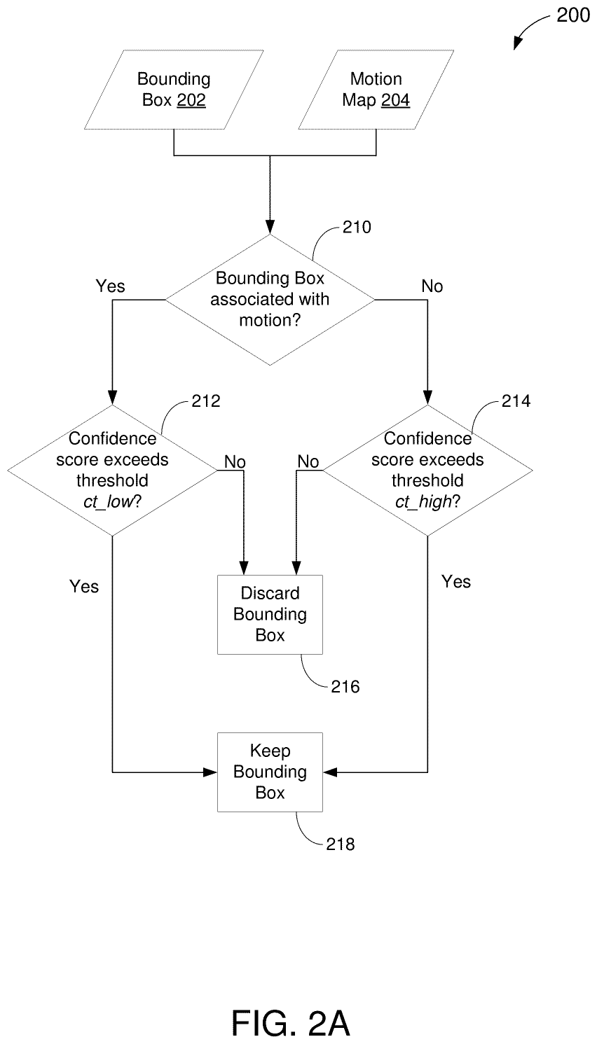

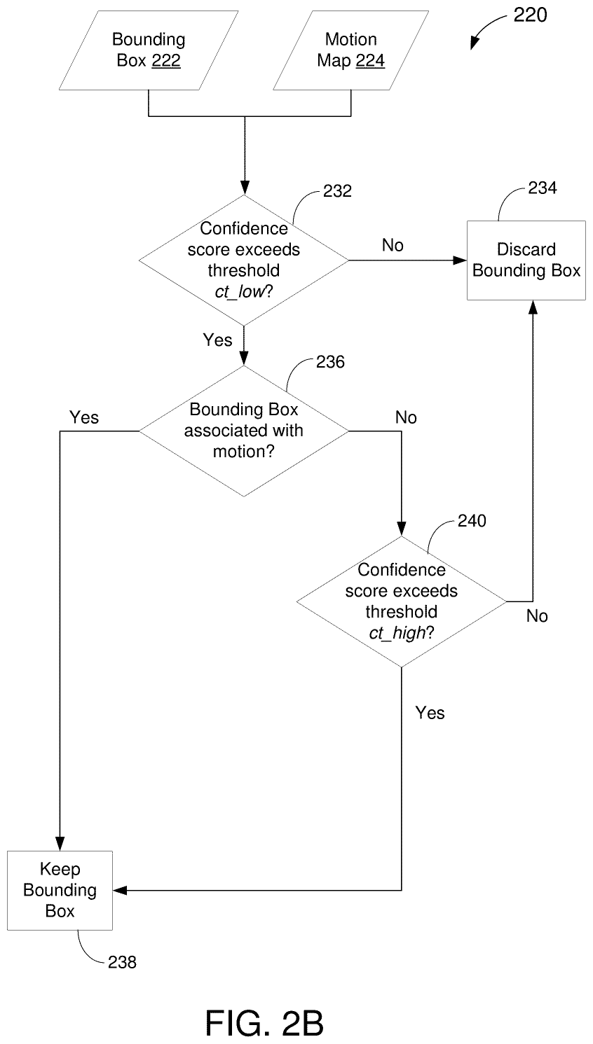

FIG. 2A shows a decision flow diagram for an example process 200 for selecting a confidence threshold and determining whether to keep or discard a bounding box based on the selected threshold, according to some implementations. Process 200 illustrates a decision flow by which the bounding box filtering component 136 may select a confidence threshold for a bounding box and determine whether to keep or discard the bounding box based on the selected confidence threshold.

Process 200 begins with the bounding box filtering component 136 receiving a bounding box 202 (e.g., as determined based on a first image in a sequence of images), the confidence score (not shown) assigned to the bounding box 202, and a motion map 204 (e.g., as determined based on the first image and one or more additional images in the sequence of images) as inputs. At step 210, the bounding box filtering component 136 determines whether the bounding box 202 is associated with motion indicated in the motion map 204 (e.g., whether the bounding box 202 overlaps with an area of detected motion in the motion map 204). If the bounding box filtering component 136 determines that the bounding box 202 is associated with motion indicated in the motion map 204 (210—Yes), then the process 200 proceeds to step 212, where the bounding box filtering component 136 selects a lower confidence threshold (e.g., ct_low) and determines whether the confidence score of bounding box 202 exceeds ct_low.

At step 212, if the bounding box filtering component 136 determines that the confidence score of the bounding box 202 exceeds ct_low (212—Yes), then the process 200 proceeds to step 218, where the bounding box filtering component 136 keeps the bounding box 202.

At step 212, if the bounding box filtering component 136 determines that the confidence score of the bounding box 202 does not exceed ct_low (212—No), then the process 200 proceeds to step 216, where the bounding box filtering component 136 discards the bounding box 202.

At step 210, if the bounding box filtering component 136 determines that the bounding box 202 is not associated with motion indicated in the motion map 204 (210—No), then the process 200 proceeds to step 214, where the bounding box filtering component 136 selects a higher confidence threshold (e.g., ct_high) and determines whether the confidence score of bounding box 202 exceeds ct_high.

At step 214, if the bounding box filtering component 136 determines that the confidence score of the bounding box 202 exceeds ct_high (214—Yes), then the process 200 proceeds to step 218, where the bounding box filtering component 136 keeps the bounding box 202.

At step 214, if the bounding box filtering component 136 determines that the confidence score of the bounding box 202 does not exceed ct_high (214—No), then the process 200 proceeds to step 216, where the bounding box filtering component 136 discards the bounding box 202.

FIG. 2B shows a decision flow diagram for another example process 220 for selecting a confidence threshold and determining whether to keep or discard a bounding box based on the selected threshold, according to some implementations. Process 220 illustrates another decision flow, similar to the process 200, by which the bounding box filtering component 136 may select a confidence threshold for a bounding box and determine whether to keep or discard the bounding box based on the selected confidence threshold.

Process 220 begins with the bounding box filtering component 136 receiving a bounding box 222, the confidence score (not shown) assigned to the bounding box 222, and a motion map 224 as inputs. At step 232, the bounding box filtering component 136 determines whether the confidence score of the bounding box 222 exceeds a lower confidence threshold (e.g., ct_low).

At step 232, if the bounding box filtering component 136 determines that the confidence score of the bounding box 222 does not exceed ct_low (232—No), then the process 200 proceeds to step 234, where the bounding box filtering component 136 discards the bounding box 222.

At step 232, if the bounding box filtering component 136 determines that the confidence score of the bounding box 222 exceeds ct_low (232—Yes), then the process 200 proceeds to step 236, where the bounding box filtering component 136 determines whether the bounding box 222 is associated with motion indicated in the motion map 224.

At step 236, if the bounding box filtering component 136 determines that the bounding box 222 is associated with motion indicated in the motion map 224 (236—Yes), then the process 220 proceeds to step 238, where the bounding box filtering component 136 keeps the bounding box 222.

At step 236, if the bounding box filtering component 136 determines that the bounding box 222 is not associated with motion indicated in the motion map 224 (236—No), then the process 220 proceeds to step 240, where the bounding box filtering component 136 determines whether the confidence score of the bounding box 222 exceeds a higher confidence threshold (e.g., ct_high).

At step 240, if the bounding box filtering component 136 determines that the confidence score of the bounding box 222 does not exceed ct_high (240—No), then the process 200 proceeds to step 234, where the bounding box filtering component 136 discards the bounding box 222.

At step 240, if the bounding box filtering component 136 determines that the confidence score of the bounding box 222 exceeds ct_high (240—Yes), then the process 200 proceeds to step 238, where the bounding box filtering component 136 keeps the bounding box 222.

Thus, process 220 illustrates an alternative implementation for selecting a confidence threshold and filtering bounding boxes based on the selected confidence threshold. In process 220, the bounding box filtering component 136 may first determine whether the confidence score of a bounding box exceeds a lower confidence threshold (e.g., ct_low). If the bounding box passes that lower confidence threshold, the bounding box filtering component 136 may determine whether the bounding box is associated with motion. If the bounding box is associated with motion, then the bounding box filtering component 136 may keep the bounding box, effectively selecting the lower confidence threshold as the threshold for keeping or discarding the bounding box. If the bounding box is not associated with motion, then the bounding box filtering component 136 determines whether the confidence score of the bounding box exceeds a higher confidence threshold (e.g., ct_high), thus selecting the higher confidence threshold as the threshold for keeping or discarding the bounding box.

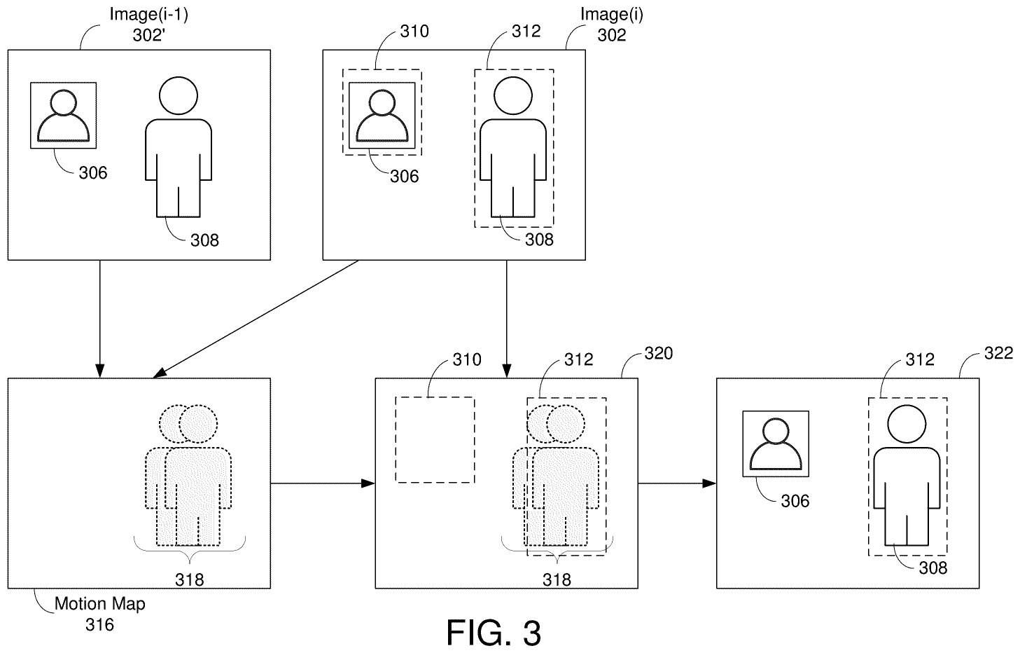

FIG. 3 shows an example set of captured images and object detection based on those images, according to some implementations. FIG. 3 illustrates images 302′ and 302, captured by an image capture component (e.g., image capture component 110). Thus, images 302′ and 302 represent the (i−1)^{th} and the i^{th} images, respectively, in a sequence of images. While FIG. 3 illustrates two images in a sequence of images used for the image analysis, more than two images may be used for the image analysis described herein.

As shown in FIG. 3, the images 302′ and 302 include objects 306 and 308. The object 308 (depicted as a person) represents an object of interest in the field of view (e.g., FOV 112) of the image capture component. The object 306 (depicted as a framed picture) represents an object of non-interest in the FOV. Further, the object 308 may be in motion throughout the images 302′ and 302, and the object 306 may be stationary throughout the images 302′ and 302.

An image analysis component (e.g., image analysis component 120) may perform an object detection operation on the image 302 based on an object detection model (e.g., object detection model 122). The image analysis component may detect objects 306 and 308 based on the object detection operation. The image analysis component may determine bounding boxes 310 and 312 for the objects 306 and 308, respectively, and assign respective confidence scores to the bounding boxes 310 and 312. The image analysis component may map the bounding boxes 310 and 312 to the image 302 at locations corresponding to objects 306 and 308, respectively.

The image analysis component further may perform a motion detection operation on images 302′ and 302 based on a motion detection model (e.g., motion detection model 124). The image analysis component may detect pixel value changes associated with the motion of the object 308 based on the motion detection operation and generate a motion map 316 indicating an area of motion 318 corresponding to the pixel value changes associated with the motion of the object 308.

A bounding box filtering component (e.g., bounding box filtering component 136) may compare 320 the bounding boxes 310 and 312 with motion map 316. Based on the comparison 320, the bounding box filtering component may determine that the bounding box 310 does not overlap with the area of motion 318, and that the bounding box 312 overlaps with the area of motion 318. Accordingly, the bounding box filtering component may determine that the bounding box 310 is not associated with motion, and that the bounding box 312 is associated with motion. Based on these determinations, the bounding box filtering component may select a higher confidence threshold (e.g., ct_high) for the bounding box 310, and select a lower confidence threshold (e.g., ct_low) for the bounding box 312.

Assuming for the example of FIG. 3 that the confidence score for both of bounding boxes 310 and 312 is 0.60, ct_low is 0.50, and ct_high is 0.75, the bounding box filtering component may determine that the confidence score of the bounding box 310 does not exceed the higher threshold (e.g., ct_high). The bounding box filtering component further may determine that the confidence score of the bounding box 312 exceeds the lower threshold (e.g., ct_low). Based on these determinations, the bounding box filtering component discards the bounding box 310 and keeps the bounding box 312. The bounding box filtering component may output a final output 322 that includes the bounding box 312, which may be displayed on an image to indicate (e.g., to a user) that the image analysis component has detected the object 308. For example, as shown in FIG. 3, the final output 322 may include the image 302 and the bounding box 312 around the object 308. Further, the discarded bounding box 310 is not included in the final output 322, thereby indicating that the image analysis component considers the detection of the object 306 to be a false detection of an object of interest.

In some implementations, the image analysis component 120 may select a confidence threshold for a bounding box based on one or more additional criteria. For example, in some implementations, the image analysis component 120 may include an object classification component (e.g., an object classification model) configured to perform object classification on a detected object (e.g., classify the object into an object type or category). In some implementations, the object detection model 122 may include the object classification component. In some implementations, the object classification component further includes an object identification component (e.g., an object identification model, a facial identification model) configured to determine the specific identity of an object (e.g., identify a specific person) based on a database of identities (e.g., a personnel database for identities of persons). The image analysis component 120 may perform an object classification (e.g., classification to a type, determination of a specific identity) operation on an object associated with a bounding box prior to the filtering of the bounding box. If the image analysis component 120 successfully classifies the object (e.g., identifies the object within the bounding box as a specific person known to a personnel database) or if the classification is one of a predetermined set of classifications or identities (e.g., persons as opposed to non-persons, certain identities), then the bounding box filtering component 136 may select a lower confidence threshold (e.g., ct_low) for the bounding box regardless of whether the bounding box is associated with motion. If the image analysis component 120 is unable to classify the object (e.g., the person is not in the personnel database, the face of the person in the image is not sufficiently detailed to perform facial identification, the object is insufficiently detailed in the image to be classified) or if the classification is not one of the predetermined set of classifications, then the bounding box filtering component 136 may select a confidence threshold for the bounding box based on the techniques described above (e.g., based on whether the bounding box is associated with motion or not). Thus, the image analysis component 120 may select a lower confidence threshold for a static object if the static object is classifiable by the image analysis component 120.

In some aspects, computer vision techniques may further include object tracking throughout a sequence of images captured across time. Object tracking may include “locking onto” an object detected in an image, continue to detect the object in subsequent images, and determine the positions of the object throughout the images. A challenge associated with detecting and tracking an object across a sequence of images is the problem of “blinking detections,” which refers to an object being not consistently detected across the images (e.g., the same object is detected within some images in the sequence and not others, even though the object is present throughout the entire sequence of images). Often, a “blinking detection” is associated with confidence scores for an object that do not remain consistently above a confidence threshold between images (e.g., the confidence score is high for one image in the sequence and low for the next image). The “blinking detections” problem may degrade the performance of the object detection and tracking by causing an object that had been detected and tracked to be treated as a new object. Aspects of this disclosure recognize that use of a single confidence threshold for object detection may contribute to the “blinking detections” problem by failing to account for changing confidence scores for the same object across the sequence of images.

FIG. 4 shows a block diagram of an example image analysis system 400, according to some implementations. In some aspects, the image analysis system 400 may be configured to detect one or more objects of interest amongst various other objects and generate inferences about the objects of interest. In some implementations, an inference may include a bounding box indicating a position of the object of interest within the image. The image analysis system 400 may further track a detected object across multiple images in a sequence of images. In some implementations, the image analysis system 400 may be an example or extension of the image analysis system 100 of FIG. 1.

The system 400 includes an image analysis component 420, a tracking component 436, and a hysteresis component 438. The image analysis component 420 may receive a sequence of images 402 as input. The images 402 may be captured by an image capture component (e.g., image capture component 110 of FIG. 1, not shown). In some implementations, the system 400 includes the image capture component, similar to system 100 of FIG. 1. The sequence of images 402 may be an example of images 114′ and 114 of FIG. 1. In some implementations, the system 400 may include a buffer (not shown) (e.g., buffer 113 of FIG. 1) configured to store the images 402. The image analysis component 420 may receive one or more of the images 402 for input from that buffer.

The image analysis component 420 is configured to detect one or more objects of interest and to determine a bounding box 432 for each detected object of interest based on one or more of the images 402. In some implementations, for each image in the sequence of images, the image analysis component 420 may detect one or more objects of interest in that image and determines a bounding box 432 for each detected object in that image. In some aspects, the image analysis component 420 may detect one or more objects of interest in the images 402, map a bounding box 432 for each detected object to at least one image in the images 402, and filter any bounding boxes 432 that correspond to potential false detections. The image analysis component 420 may assign a confidence score to each bounding box. In some implementations, the image analysis component 420 is an example or extension of the image analysis component 120.

In some aspects, the image analysis component 420 may detect one or more objects, and determine one or more corresponding bounding boxes 432, based on an object detection model 422. In some implementations, the object detection model 422 may be an example of the object detection model 122 of FIG. 1. Thus, the image analysis component 420 may output, based on the object detection model 422, one or more bounding boxes 432 and respective confidence scores.

The image analysis system 400 may be further configured to track one or more detected objects across multiple images (or a sequence of images). In some aspects, the image analysis system 400 may output a tracker 442 for an object of interest by comparing the bounding boxes 432 extracted from a first image in the sequence of images (e.g., the i^{th} image) with the bounding boxes 432 extracted from a second image in the sequence of images (e.g., the (i−1)^{th} image). As used herein, a “tracker” refers to any bounding box that is associated with a previously detected (or “tracked”) object or a new object to be tracked by the image analysis system 400.

The tracking component 436 may receive one or more bounding boxes 432 and their respective confidence scores as inputs. The tracking component 436 may further receive one or more trackers 442 and determine, for each of the bounding boxes 432, whether that bounding box is associated with a previously-detected object.

In some implementations, the tracking component 436 may determine whether a bounding box 432 is associated with a previously-detected object based on a distance function (e.g., whether the position of the bounding box 432 is within a predetermined distance threshold from the position of a tracker 442). If the bounding box 432 is within a threshold distance of a tracker 442, then the tracking component 436 may determine that the bounding box 432 is associated with a previously-detected object. Otherwise, the tracking component 436 may determine that the bounding box 432 is not associated with any previously-detected object. In some implementations, the distance may be measured from a centroid of the bounding box to a centroid of the tracker. The tracking component 436 may output tracking data 434 indicating whether a bounding box 432 is associated with a previously detected object. In some implementations, the tracking data 434 may include identifiers of detected objects and mappings between detected objects and respective bounding boxes 432. In some implementations, the tracking data 434 may also indicate which trackers 442 are within the distance threshold from the bounding box 432.

In some implementations, the hysteresis component 438 may be configured to select a confidence threshold for filtering each of the bounding boxes 432 based on the tracking data 434. For example, the hysteresis component 438 may select a higher confidence threshold (e.g., ct_n) or a lower confidence threshold (e.g., ct_h) for filtering the bounding box depending on whether the tracking data 434 indicates that the bounding box is associated with a previously detected object. In some implementations, the hysteresis component 438 may select the higher confidence threshold ct_n for a bounding box if the tracking data 434 indicates that the bounding box is not associated with a previously-detected object. In some other implementations, the hysteresis component 438 may select the lower confidence threshold ct_h for a bounding box if the tracking data 434 indicates that the bounding box is associated with a previously-detected object.

If the confidence score of a given bounding box 432 exceeds the selected confidence threshold for the bounding box, the hysteresis component 438 may keep the bounding box 432. On the other hand, if the confidence score of a given bounding box 432 is below the selected confidence threshold for the bounding box, the hysteresis component 438 may discard the bounding box 432. The hysteresis component 438 may output any bounding boxes 432 that are not discarded as respective trackers 442. The tracking component 436 may further use the trackers 442 as historical information for generating tracking data 434 for subsequent images.

In some implementations, the lower confidence threshold ct_h may be equal to the higher confidence threshold ct_n, multiplied by a hysteresis adjustment factor to lower the threshold. In some implementations, the value for ct_n may be 0.80 (on a scale from 0 to 1, where 0 represents the lowest possible confidence score and 1 represents the highest possible confidence score), and the hysteresis adjustment factor may be 0.80, which results in a value for ct_h of 0.64. In some implementations, the values for ct_n and the hysteresis adjustment factor may be predetermined and configured based on empirical experimentation and testing (e.g., tested and validated using test image inputs). Further, in some implementations, ct_high (described above with respect to FIG. 1) and ct_n may be the same. Moreover, in some implementations, ct_h may be, instead of being equal to ct_n multiplied by a hysteresis adjustment factor, a predetermined threshold that is set to be lower than ct_n. In some implementations, ct_h may be the same as ct_low (described above with respect to FIG. 1).

FIG. 4 illustrates the tracking component 436 and the hysteresis component 438 as distinct components from the image analysis component 420. In some implementations, the tracking component 436 and/or the hysteresis component 438 may be included or integrated within the image analysis component 420.

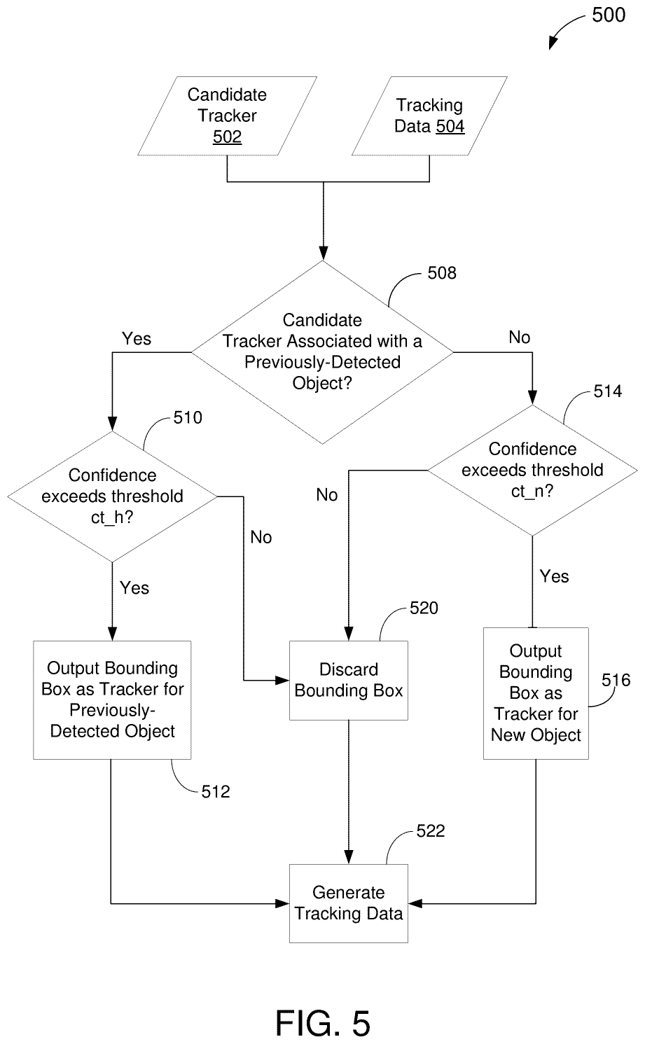

FIG. 5 shows a decision flow diagram for an example process 500 for detecting and tracking an object, according to some implementations. Process 500 illustrates a decision flow by which the hysteresis component 438 may select a confidence threshold based on whether a bounding box is associated with a previously-detected object, and whether the confidence score of the bounding box exceeds the selected confidence threshold.

Process 500 begins with the hysteresis component 438 receiving a bounding box 502 (e.g., as determined based on an i^{th} image), the confidence score (not shown) assigned to the bounding box 502, and tracking data 504 (e.g., as determined based on images preceding the i^{th} image) as inputs. The bounding box 502 may be an example of a bounding box 432, and the tracking data 504 may be an example of the tracking data 434.

At step 508, the hysteresis component 438 determines whether the bounding box 502 is associated with a previously-detected object based on the tracking data 504. If the tracking data 504 indicates that the bounding box 502 is not associated with any previously-detected object, then the process 500 proceeds to step 514, thereby selecting ct_n as a confidence threshold. If the tracking data 504 indicates that the bounding box 502 is associated with a previously-detected object, then the process 500 proceeds to step 510, thereby selecting ct_h as a confidence threshold.

At step 514, the hysteresis component 438 determines whether the confidence score of the bounding box 502 exceeds the confidence threshold ct_n. If the hysteresis component 438 determines that the confidence score of the bounding box 502 exceeds ct_n (514—Yes), then the process 500 proceeds to step 516, where the hysteresis component 438 keeps the bounding box 502 and associates the bounding box 502 with the corresponding, newly detected object. The image analysis system 400 may output the bounding box 502 as a tracker 442 for the newly detected object. The process 500 then proceeds to step 522.

At step 514, if the hysteresis component 438 determines that the confidence score of the bounding box 502 does not exceed ct_n (514—No), then the process 500 proceeds to step 520, where the hysteresis component 438 discards the bounding box 502. The process 500 then proceeds to step 522.

At step 510, the hysteresis component 438 determines whether the confidence score of the bounding box 502 exceeds the confidence threshold ct_h. If the hysteresis component 438 determines that the confidence score of the bounding box 502 exceeds ct_h (510—Yes), then the process 500 proceeds to step 512, where the hysteresis component 438 keeps the bounding box 502 and associate the bounding box 502 with the corresponding, previously detected object. The image analysis system 400 may output the bounding box 502 as a tracker 442 for the previously detected object. In some implementations, the bounding box 502 is associated with the previously-detected object associated with the tracker that is closest to the bounding box 502 and whose distance is within the distance threshold. In some implementations, the image analysis system 400 may update an existing tracker 442 for the previously detected object based on the bounding box 502 (e.g., replace the existing tracker 442 with the bounding box 502 as the new tracker, taking a weighted average between the positions of the existing tracker 442 and the bounding box 502, applying a Kalman filtering technique to the existing tracker 442 and the bounding box 502). The process 500 then proceeds to step 522.

At step 510, if the hysteresis component 438 determines that the confidence score of the bounding box 502 does not exceed ct_h (510—No), then the process 500 proceeds to step 520, where the hysteresis component 438 discards the bounding box 502. The process 500 then proceeds to step 522.

At step 522, the hysteresis component 438 may generate tracking data. For example, the hysteresis component 438 may update the tracking data 504 with mappings of previously-detected and newly-detected objects to respective bounding boxes that are output as trackers. The hysteresis component 438 may also remove mappings of objects to stale trackers (e.g., a tracker that is not updated or output based on a bounding box 502 kept in step 512 or 516).

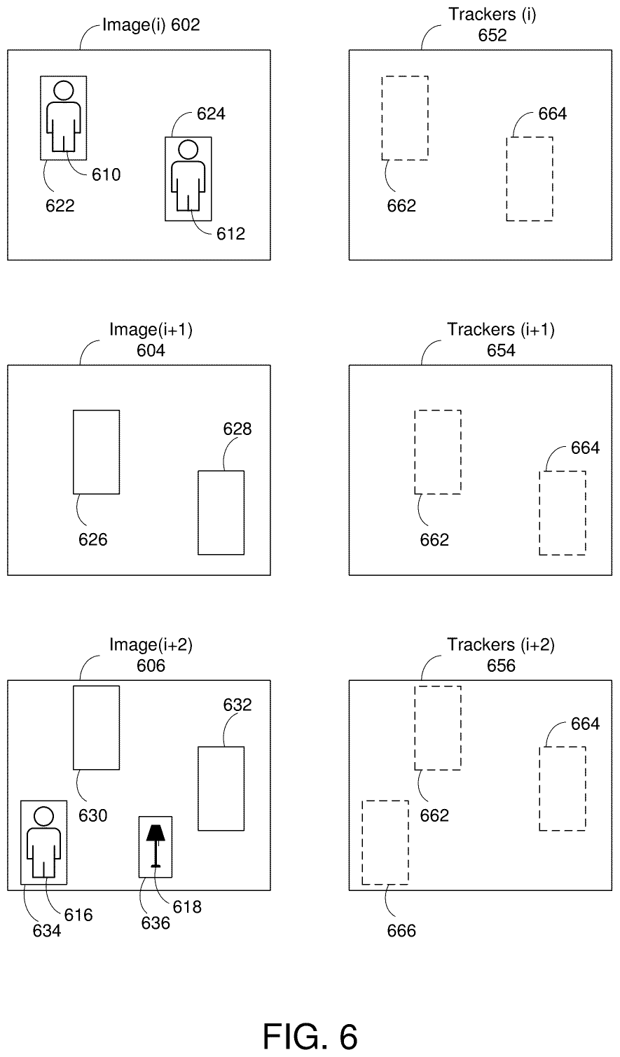

FIG. 6 shows a sequence of captured images and associated trackers, according to some implementations. FIG. 6 illustrates images 602, 604, and 606, captured by an image capture component (e.g., image capture component 110). Images 602, 604, and 606 represent the i^{th}, (i+1)^{th}, and (i+2)^{th} images, respectively, in a sequence of images. While FIG. 6 illustrates a sequence of three images used for the image analysis, any number of two or more images may be used for the image analysis described herein.

As shown in FIG. 6, image 602 includes objects 610 and 612 representing objects of interest, both depicted as persons. An image analysis system (e.g., image analysis system 400) may perform an object detection operation on the image 602, detect objects 610 and 612, and determine bounding boxes 622 and 624 for objects 610 and 612, respectively. The image analysis system 400 may further output the bounding boxes 622 and 624 as trackers 662 and 664, respectively, in a set of trackers 652 for the image 602.

For image 604, the image analysis system may determine bounding boxes 626 and 628. The image analysis system (e.g., tracking component 436) may determine that the bounding box 626 is associated with a previously detected object (e.g., object 610) based on the distance between the bounding box 626 and the tracker 662. Similarly, the image analysis system may determine that the bounding box 628 is associated with a previously detected object (e.g., object 612) based on the distance between the bounding box 628 and the tracker 664. Accordingly, the image analysis system (e.g., hysteresis component 438) may select a lower confidence threshold (e.g., ct_h) for the bounding boxes 626 and 628. Assuming that the confidence threshold ct_h is 0.64, and the confidence scores for the bounding boxes 626 and 628 are 0.70 and 0.65, respectively, then the hysteresis component may determine that both confidence scores exceed ct_h and thus may keep both bounding boxes 626 and 628. The image analysis system 400 may output the bounding boxes 626 and 628 as updated trackers 662 and 664, respectively, in a set of trackers 654 for the image 604.

For image 606, the image analysis system may determine bounding boxes 630, 632, 634, and 636. The tracking component may determine that bounding box 630 is associated with a previously detected object (e.g., object 610) based on the distance between the bounding box 630 and the tracker 662. Similarly, the image analysis system may determine that the bounding box 632 is associated with a previously detected object (e.g., object 612) based on the distance between the bounding box 632 and the tracker 664. Thus, the hysteresis component may select the lower confidence threshold ct_h for the bounding boxes 630 and 632. Assuming that the confidence scores for the candidate bounding boxes 630 and 632 are 0.66 and 0.77 respectively, then the hysteresis component may determine that both confidence scores exceed ct_h and thus may keep both bounding boxes 630 and 632. The image analysis system may output the bounding boxes 630 and 632 as updated trackers 662 and 664, respectively, in a set of trackers 656 for the image 606.

The hysteresis component may determine that bounding boxes 634 and 636 are not associated with any previously detected object based on the distance between the bounding box 634 or 636 and the trackers 662 and 664. Thus, the hysteresis component may select a higher confidence threshold ct_n for the bounding boxes 634 and 636. Assuming that the confidence scores for the bounding boxes 634 and 636 are 0.90 and 0.70 respectively, the hysteresis component may determine that the confidence score for the bounding box 634 exceeds the selected threshold ct_n, and the confidence score for the bounding box 636 does not exceed the selected threshold ct_n. Thus, the hysteresis component may keep bounding box 634 and discard bounding box 636. As shown in FIG. 6, the bounding box 634 is associated with a new object of interest 616, and the bounding box 636 is associated with an object of non-interest 618 (depicted as a lamp stand). Further, the image analysis system may output the bounding box 634 as a new tracker 666 in the set of trackers 656.

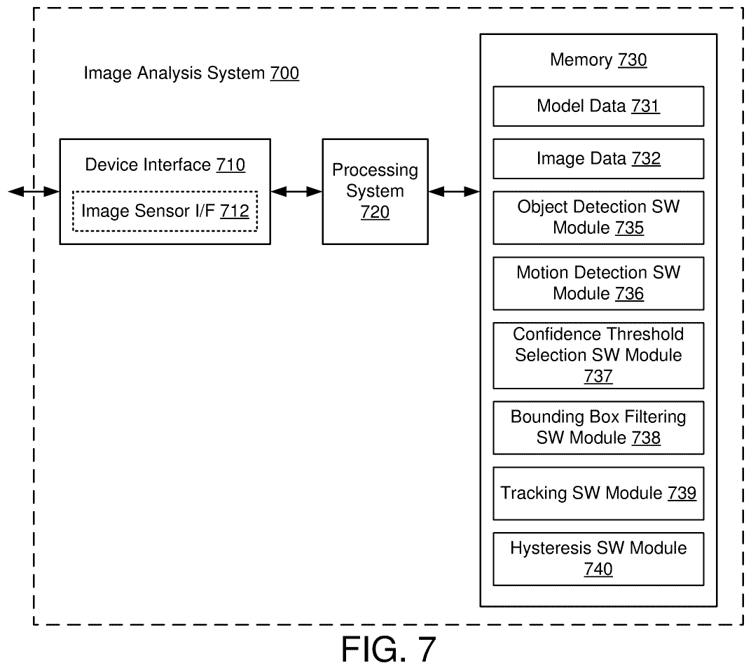

FIG. 7 shows another block diagram of an example image analysis system 700, according to some implementations. More specifically, the image analysis system 700 may be configured to detect one or more objects of interest in one or more images. Further, the image analysis system 700 may be configured to determine respective bounding boxes for detected objects and to filter those bounding boxes to discard false detections. In some implementations, the image analysis system 700 may be one example of the image analysis system 100 of FIG. 1, the image analysis system 400 of FIG. 4, or a combination of the systems 100 and 400. The image analysis system 700 includes a device interface 710, a processing system 720, and a memory 730.

The device interface 710 is configured to communicate with one or more components of an image capture device (such as the image capture component 110 of FIG. 1). In some implementations, the device interface 710 may include an image sensor interface (I/F) 712 configured to receive an image via an image capture device. In some implementations, the image sensor interface 712 may capture a sequence of images across time.

The memory 730 may include a data store 731 configured to store one or more models for object detection and/or motion detection, and a data store 732 configured to store one or more received images output data of analyses of images, including for example bounding box data. The memory 730 also may include a non-transitory computer-readable medium (including one or more nonvolatile memory elements, such as EPROM, EEPROM, Flash memory, or a hard drive, among other examples) that may store at least the following software (SW) modules:
an object detection SW module 735 to detect an object based on a first image and to determine a bounding box for the detected object;
a motion detection SW module 736 to detect motion based on the first image and a second image;
a confidence threshold selection SW module 737 to select a confidence threshold for a bounding box based on whether the bounding box is associated with motion;
a bounding box filtering SW module 738 to filter a bounding box based on the selected threshold;
tracking SW module 739 to determine whether a bounding box is associated with previously detected object; and
a hysteresis SW module 740 to select a confidence threshold for a bounding box based on whether the bounding box is associated with a previously detected object and to filter the bounding box based on the selected threshold.
   Each software module includes instructions that, when executed by the processing system 720, causes the image analysis system 700 to perform the corresponding functions.

The processing system 720 may include any suitable one or more processors capable of executing scripts or instructions of one or more software programs stored in the image analysis system 700 (such as in the memory 730). For example, the processing system 720 may execute the object detection SW module 735 to detect an object based on a first image and to determine a bounding box for the detected object, and may execute the confidence threshold selection SW module 737 to select a confidence threshold for a bounding box.

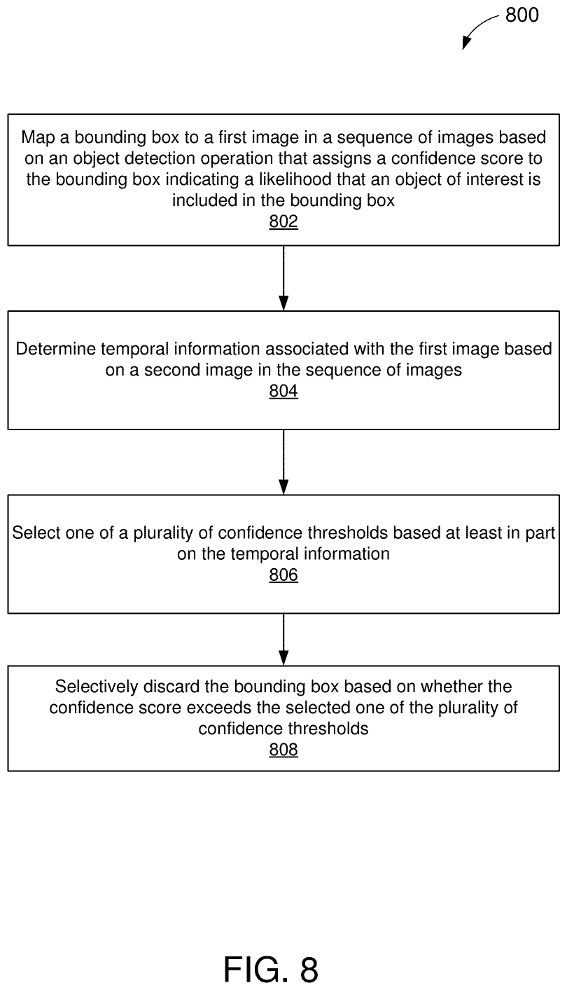

FIG. 8 shows an illustrative flowchart depicting an example operation 800 for object detection, according to some implementations. In some implementations, the example operation 800 may be performed by an image analysis system such as the image analysis system 100 of FIG. 1.

The image analysis system may map a bounding box to a first image in a sequence of images based on an object detection operation that assigns a confidence score to the bounding box indicating a likelihood that an object of interest is included in the bounding box (802). The image analysis system may determine temporal information associated with the first image based on a second image in the sequence of images (804). The image analysis system may selecting one of a plurality of confidence thresholds based at least in part on the temporal information (806). The image analysis system may selectively discard the bounding box based on whether the confidence score exceeds the selected one of the plurality of confidence thresholds (808).

In some aspects, the image analysis system may compare the first image with the second image; and determine whether the bounding box is associated with motion based on comparing the first image with the second image.

In some aspects, the image analysis system may select a first confidence threshold of the plurality of confidence thresholds responsive to determining that the bounding box is associated with motion; and select a second confidence threshold of the plurality of confidence thresholds responsive to determining that the bounding box is not associated with motion, wherein the second confidence threshold is higher than the first confidence threshold.

In some aspects, the image analysis system may discard the bounding box responsive to determining that the confidence score does not exceed the selected one of the plurality of confidence thresholds.

In some aspects, the image analysis system may keep the bounding box responsive to determining that the confidence score exceeds the selected one of the plurality of confidence thresholds.

In some aspects, the image analysis system may compare the bounding box with one or more bounding boxes mapped to the second image; and determine whether the bounding box is associated with a previously detected object based on comparing the bounding box with the one or more bounding boxes mapped to the second image.

In some aspects, the image analysis system may determine a distance between the bounding box and each of the one or more bounding boxes mapped to the second image; and compare the distances between the bounding box and the one or more bounding boxes mapped to the second image with a threshold distance.

In some aspects, the image analysis system may select a first confidence threshold of the plurality of confidence thresholds responsive to determining that the bounding box is associated with a previously detected object; and select a second confidence threshold of the plurality of confidence thresholds responsive to determining that the bounding box is not associated with a previously detected object, wherein the second confidence threshold is higher than the first confidence threshold.

In some aspects, the image analysis system may classify an object associated with the bounding box, the selecting of one of the plurality of confidence thresholds being further based on the classification of the object.

In some aspects, the image analysis system may determine an identify of the object.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method, comprising:
mapping a bounding box to a first image in a sequence of images based on an object detection operation that assigns a confidence score to the bounding box indicating a likelihood that an object of interest is included in the bounding box;
determining temporal information associated with the first image based on a second image in the sequence of images;
selecting one of a plurality of confidence thresholds based at least in part on the temporal information; and
selectively discarding the bounding box based on whether the confidence score exceeds the selected one of the plurality of confidence thresholds.

2. The method of claim 1, wherein the determining of the temporal information comprises:
comparing the first image with the second image; and
determining whether the bounding box is associated with motion based on comparing the first image with the second image.

3. The method of claim 2, wherein the selecting of one of the plurality of confidence thresholds comprises:
selecting a first confidence threshold of the plurality of confidence thresholds responsive to determining that the bounding box is associated with motion; and
selecting a second confidence threshold of the plurality of confidence thresholds responsive to determining that the bounding box is not associated with motion, wherein the second confidence threshold is higher than the first confidence threshold.

4. The method of claim 1, wherein the selective discarding of the bounding box comprises discarding the bounding box responsive to determining that the confidence score does not exceed the selected one of the plurality of confidence thresholds.

5. The method of claim 1, wherein the selective discarding of the bounding box comprises keeping the bounding box responsive to determining that the confidence score exceeds the selected one of the plurality of confidence thresholds.

6. The method of claim 1, wherein the determining of the temporal information comprises:
comparing the bounding box with one or more bounding boxes mapped to the second image; and
determining whether the bounding box is associated with a previously detected object based on comparing the bounding box with the one or more bounding boxes mapped to the second image.

7. The method of claim 6, wherein the determining of whether the bounding box is associated with a previously detected object comprises:
determining a distance between the bounding box and each of the one or more bounding boxes mapped to the second image; and
comparing the distances between the bounding box and the one or more bounding boxes mapped to the second image with a threshold distance.

8. The method of claim 7, wherein the selecting of one of the plurality of confidence thresholds comprises:
selecting a first confidence threshold of the plurality of confidence thresholds responsive to determining that the bounding box is associated with a previously detected object; and
selecting a second confidence threshold of the plurality of confidence thresholds responsive to determining that the bounding box is not associated with a previously detected object, wherein the second confidence threshold is higher than the first confidence threshold.

9. The method of claim 1, further comprising:
classifying an object associated with the bounding box, the selecting of one of the plurality of confidence thresholds being further based on the classification of the object.

10. The method of claim 9, wherein the classifying of the object comprises determining an identify of the object.

11. A computing system, comprising:
one or more processors; and
a memory coupled to the one or more processors, the memory storing instructions that, when executed by the one or more processors, cause the computing system to:
map a bounding box to a first image in a sequence of images based on an object detection operation that assigns a confidence score to the bounding box indicating a likelihood that an object of interest is included in the bounding box;
determine temporal information associated with the first image based on a second image in the sequence of images;
select one of a plurality of confidence thresholds based at least in part on the temporal information; and
selectively discard the bounding box based on whether the confidence score exceeds the selected one of the plurality of confidence thresholds.

12. The computing system of claim 11, wherein the instructions, when executed by the one or more processors, further cause the computing system to:
compare the first image with the second image; and
determine whether the bounding box is associated with motion based on comparing the first image with the second image.

13. The computing system of claim 12, wherein the instructions, when executed by the one or more processors, further cause the computing system to:
select a first confidence threshold of the plurality of confidence thresholds responsive to determining that the bounding box is associated with motion; and
select a second confidence threshold of the plurality of confidence thresholds responsive to determining that the bounding box is not associated with motion, wherein the second confidence threshold is higher than the first confidence threshold.

14. The computing system of claim 11, wherein the instructions, when executed by the one or more processors, further cause the computing system to discard the bounding box responsive to determining that the confidence score does not exceed the selected one of the plurality of confidence thresholds.

15. The computing system of claim 11, wherein the instructions, when executed by the one or more processors, further cause the computing system to keep the bounding box responsive to determining that the confidence score exceeds the selected one of the plurality of confidence thresholds.

16. The computing system of claim 11, wherein the instructions, when executed by the one or more processors, further cause the computing system to:
compare the bounding box with one or more bounding boxes mapped to the second image; and
determine whether the bounding box is associated with a previously detected object based on comparing the bounding box with the one or more bounding boxes mapped to the second image.

17. The computing system of claim 16, wherein the instructions, when executed by the one or more processors, further cause the computing system to:
determine a distance between the bounding box and each of the one or more bounding boxes mapped to the second image; and
compare the distances between the bounding box and the one or more bounding boxes mapped to the second image with a threshold distance.

18. The computing system of claim 17, wherein the instructions, when executed by the one or more processors, further cause the computing system to:
select a first confidence threshold of the plurality of confidence thresholds responsive to determining that the bounding box is associated with a previously detected object; and
select a second confidence threshold of the plurality of confidence thresholds responsive to determining that the bounding box is not associated with a previously detected object, wherein the second confidence threshold is higher than the first confidence threshold.

19. The computing system of claim 11, wherein the instructions, when executed by the one or more processors, further cause the computing system to classify an object associated with the bounding box, the selecting of one of the plurality of confidence thresholds being further based on the classification of the object.

20. The computing system of claim 19, wherein the instructions, when executed by the one or more processors, further cause the computing system to determine an identify of the object.
